(19) United States
(12) Patent Application Publication
(10) Pub. No.: US 2015/0315973 A1
(43) Pub. Date: Nov. 5, 2015

(54) SYSTEM FOR DETECTING A FLASHBACK AND MITIGATING DAMAGE FROM THE FLASHBACK TO A COMBUSTION SYSTEM

(71) Applicant: Solar Turbines Incorporated, San Diego, CA (US)

(72) Inventors: David Tai Wai Lee, Singapore (SG); Edouard Bahous, San Diego, CA (US); Steven MIchael Skinner, San Diego, CA (US)

(73) Assignee: Solar Turbines Incorporated, San Diego, CA (US)

(21) Appl. No.: 14/269,483

(22) Filed: May 5, 2014

(51) Int. Cl. F02C 7/25

(52) U.S. Cl. CPC F02C 7/25

(57) ABSTRACT

A system is provided for detecting and mitigating damage from flashback in a combustion system. The combustion system includes an injector and a combustor. The system includes a supply line coupled to the combustor. The supply line defines an end configured to face with the combustor. The end is provided with a fusible component that is configured to melt in the event of a flashback and release an extinguishing agent into the combustor.

### TECHNICAL FIELD

The present disclosure relates to a system for detecting a flashback condition in a combustion system, and more particularly to a system for detecting a flashback and mitigating damage to a combustion system from the flashback.

### BACKGROUND

Combustion systems may be designed to prevent an occurrence of flashback therein. However, in some cases, flashback may occur due to insufficient fuel velocity from a nozzle, an injector, or at a burner of the combustion system. During flashback, the flame may travel upstream against the flow of fuel/air mixture and come in contact with the nozzle or the injector. In such cases, the extreme temperatures resulting from flashback may deteriorate the nozzle or the injector.

Many systems and methods have been developed in the past to prevent the contact of flashback with injectors of combustion systems. For reference, Canadian Patent No. 2 694 080 relates to a specially designed protective system for a fuel-fired water heater. The protective system is operative to detect a flame flashback condition in a main burner and responsively shut down the water heater. However, such systems may be slow in detecting the flashback while also allowing the flashback to come into contact with the nozzle or the injector of the combustion system.

### SUMMARY

In one aspect, the present disclosure discloses a system for detecting a flashback condition and mitigating damage from the flashback in a combustion system. The combustion system includes an injector and a combustor. The system includes a supply line coupled to the combustor. The supply line defines an end configured to face with the combustor. The end is provided with a fusible component that is configured to melt in the event of a flashback and release an extinguishing agent into the combustor.

In another aspect, the present disclosure discloses a system for detecting a flashback condition and mitigating damage from the flashback in a combustion system. The combustion system includes an injector and a combustor. The system includes a supply line located downstream of the injector and coupled to the combustor. The supply line is configured to selectively supply an extinguishing agent within the combustor. The system further includes a fusible component affixed to an end of the supply line. The fusible component is operable to melt in the event of a flashback and release the extinguishing agent into the combustor.

In another aspect, the present disclosure provides a method of detecting a flashback condition and mitigating damage from the flashback in a combustion system having an injector and a combustor. The method includes supplying fuel to the combustor via the injector. The method further includes maintaining a supply line charged with an extinguishing agent, wherein an end of the supply line is coupled to the combustor. The method further includes providing a fusible component at the end of the supply line, the fusible component operable to melt in the event of a flashback and release the extinguishing agent into the combustor.

Other features and aspects of this disclosure will be apparent from the following description and the accompanying drawings.

### BRIEF DESCRIPTION OF THE DRAWINGS

FIG. 1 is a schematic representation of an exemplary combustion system, and a system for detecting flashback in accordance with an embodiment of the present disclosure;

FIG. 2 is a schematic representation of the system showing a supply line being charged with an extinguishing agent prior to operating a combustor of the combustion system;

FIG. 3 is a schematic representation of the exemplary combustion system showing the flow of fuel and air into a combustor;

FIG. 4 is a schematic representation of the exemplary combustion system showing ignition of fuel in the combustor and the occurrence of a flashback therein;

FIG. 5 is a schematic representation of the exemplary combustion system showing a stop in the flow of fuel and a release of the extinguishing agent into the combustor;

FIG. 6 is a schematic representation of a combustion system showing locations at which fusible components pursuant to embodiments of the present disclosure may be installed;

FIG. 7 is a diagrammatic representation of an exemplary injector showing locations at which fusible components pursuant to embodiments of the present disclosure may be installed; and

FIG. 8 is a method of detecting a flashback condition in the combustion system.

### DETAILED DESCRIPTION

Wherever possible, the same reference numbers will be used throughout the drawings to refer to same or like parts. Moreover, references to various elements described herein are made collectively or individually when there may be more than one element of the same type. However, such references are merely exemplary in nature. It may be noted that any reference to elements in the singular is also to be construed to relate to the plural and vice-versa without limiting the scope of the disclosure to the exact number or type of such elements unless set forth explicitly in the appended claims.

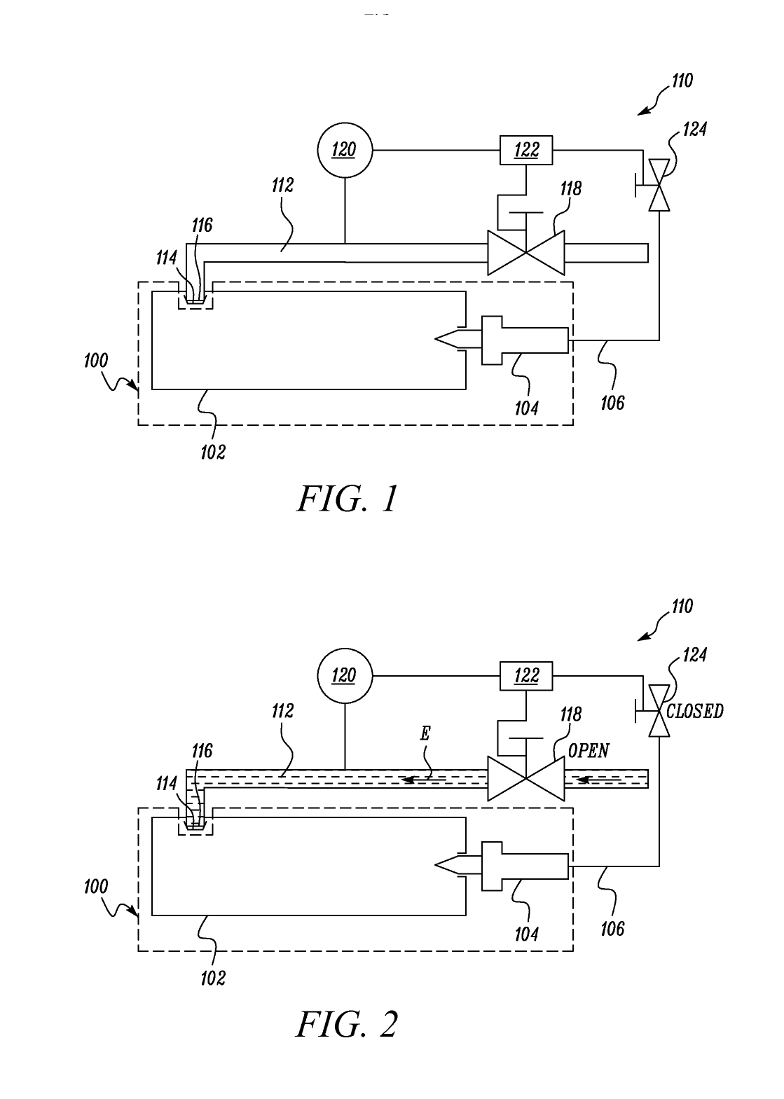

FIG. 1 shows a schematic representation of an exemplary combustion system 100 in which disclosed embodiments may be implemented. In an embodiment, the combustion system 100 may be part of a gas turbine engine (not shown). In another embodiment, the combustion system 100 may be part of an industrial boiler. In yet another embodiment, the combustion system 100 may be part of a burner system in any commonly known industrial application.

Although explanation pertaining to some embodiments of the present disclosure may be made in conjunction with a combustion system of a gas turbine engine, one of ordinary skill in the art will appreciate that the present disclosure can be equally applied to combustion systems from other industrial settings. Therefore, the present disclosure should not be construed as being limited to the specific embodiments disclosed herein; rather, the present disclosure extends to other industrial applications where flashback may be a possible phenomenon, observed, or otherwise known to occur.

Referring to FIG. 1, the exemplary combustion system 100 includes a combustor 102, and an injector 104. The injector 104 is coupled to the combustor 102 and is configured to operatively provide a supply of pressurized fuel to the combustor 102. For purposes of the present disclosure, it may be noted that although a combustor 102 is disclosed herein, an injector nozzle can be suitably provided in lieu of the combustor 102. Therefore, one of ordinary skill in the art will acknowledge that embodiments of the present disclosure may be implemented by way of the combustor 102 or optionally by way of the injector nozzle without deviating from the spirit of the present disclosure.

As illustrated, the combustion system 100 includes a fuel line 106 coupled to the injector 104. The fuel line 106 is configured to operatively supply the fuel to the injector 104 so that the injector 104 may operatively provide the supplied fuel to the combustor 102. In an embodiment, the injector 104 may be configured to supply pre-mixed fuel to the combustor 102. Alternatively, the injector 104 may supply gasoline, diesel, or natural gas to the combustor 102 depending on the type and/or configuration of the combustion system 100.

The present disclosure relates to a system 110 for detecting a flashback condition and mitigating damage from the flashback in a combustion system 100. The system 110 includes a supply line 112 located downstream of the injector 104 and coupled to the combustor 102. The supply line 112 is configured to selectively supply an extinguishing agent E into the combustor 102, in accordance with embodiments of the present disclosure.

In one embodiment, the extinguishing agent E may be carbon dioxide (CO₂). However, in alternative embodiments of the present disclosure, the extinguishing agent E may include a combination of water (H₂O) and foam, or may be of a dry or wet chemical type, as commonly known in the art. Further explanation to the selective supply of the extinguishing agent E into the combustor 102 will be made later in this document.

As shown, the system 110 additionally includes a fusible component 114 affixed to an end 116 of the supply line 112. The fusible component 114 is configured to melt at a temperature in the range of 900 to 2000 degrees Fahrenheit. In one embodiment, the fusible component 114 may be configured to melt at a temperature of above 1000 degrees Fahrenheit. In another embodiment, the fusible component 114 may be configured to melt at a temperature of above 1250 degrees Fahrenheit. In yet another embodiment, the fusible component 114 may be configured to melt at a temperature of above 1500 degrees Fahrenheit.

With reference to the fusible component 114, one of ordinary skill in art will acknowledge that a melting point temperature of the fusible component 114 may depend on the material with which the fusible component 114 is formed. In an embodiment, the fusible component 114 may be made up of a metal. The metal may be, but is not limited to, Copper (Cu), Aluminum (Al), Rhodium (Rh), Titanium (Ti), Iron (Fe), or any other metal commonly known to in the art.

In an alternative embodiment, the fusible component 114 may be made up of an alloy such as, but not limited to, Copper based alloys, Bismuth based alloys, Zinc based alloys, or other alloys commonly known to one skilled in the art. For example, the alloy may be Indalloy #178.

The system 110 further includes a first valve 118 disposed in the supply line 112 and located upstream of the fusible component 114. The first valve 118 is configured to regulate a supply of the extinguishing agent E into the supply line 112. The first valve 118 disclosed herein may be of a solenoid operated type and may include, for example, a check valve, a spool valve, a gate valve, or any other type of valve commonly known to one skilled in the art.

Moreover, the system 110 further includes a pressure transmitter 120 disposed in the supply line 112. As shown, the pressure transmitter 120 is located between the fusible component 114 and the first valve 118. The pressure transmitter 120 is configured to measure a pressure of the extinguishing agent E within the supply line 112.

In one embodiment, the pressure transmitter 120 may be configured to output static pressure of the extinguishing agent E. Alternatively, the pressure transmitter 120 may output dynamic pressure values of the extinguishing agent E. Therefore, the term “pressure” disclosed herein, may be regarded as the static or dynamic pressure depending on whether the extinguishing agent is flowing through or merely residing in the supply line 112.

Moreover, in an embodiment, the pressure transmitter 120 may be configured to measure the pressure of the extinguishing agent E relative to a reference value of atmospheric pressure. In another embodiment, the pressure transmitter 120 may be configured to provide an absolute pressure value of the extinguishing agent E present in the supply line 112. Accordingly, the pressure transmitter 120 may be for example, an absolute pressure sensor, a gauge pressure sensor, a vacuum pressure sensor, a differential pressure sensor, and a sealed pressure sensor. However, it may be noted that in alternative embodiments, the pressure transmitter 120 may be implemented by way of any other type commonly known to one skilled in the art.

Moreover, the system 110 includes a controller 122 communicably coupled to the pressure transmitter 120 and the first valve 118. Additionally or optionally, the controller 122 may also be connected to a second valve 124 disposed in the fuel line 106. The second valve 124 is operably configured to regulate a flow of fuel to the injector 104 as will be explained later herein.

A person having ordinary skill in the art will appreciate that the controller 122 may be embodied in the form of an ECM (electronic control module) package and may be readily implemented for use in the system 110. The ECM may include various associated system hardware and/or software components such as, for example, input/output (I/O) devices, analog-to-digital (A/D) converters, processors, micro-processors, chipsets, read-only memory (ROM), random-access memory (RAM), and secondary storage devices, but not limited thereto. Such associated system hardware may be configured with various logic gates and/or suitable programs, algorithms, routines, protocols in order to execute the functions of the controller 122 consistent with the present disclosure.

Referring to FIG. 2, the combustion system 100 and the system 110 for detecting flashback are shown at an instant prior to operation of the combustion system 100. At this point, the supply line 112 is charged with the extinguishing agent E. As shown, the first valve 118 is disposed in the open state to allow the extinguishing fluid to fill up between the first valve 118, and the fusible component 114 affixed at the end 116 of the supply line 112.

The first valve 118 is kept open until a pre-determined amount of extinguishing fluid is reached between the first valve 118, and the fusible component 114 affixed at the end 116 of the supply line 112. This pre-determined amount of extinguishing fluid, disclosed herein, corresponds to a pre-determined threshold pressure limit to which the supply line 112 may be filled with the extinguishing agent E. As such, the controller 122 issues appropriate command signals to the first valve 118 in order to execute an opening or closing of the first valve 118. Moreover, the fusible component 114 serves as an end stop to the extinguishing agent E so that the extinguishing agent E may be contained within the supply line 112.

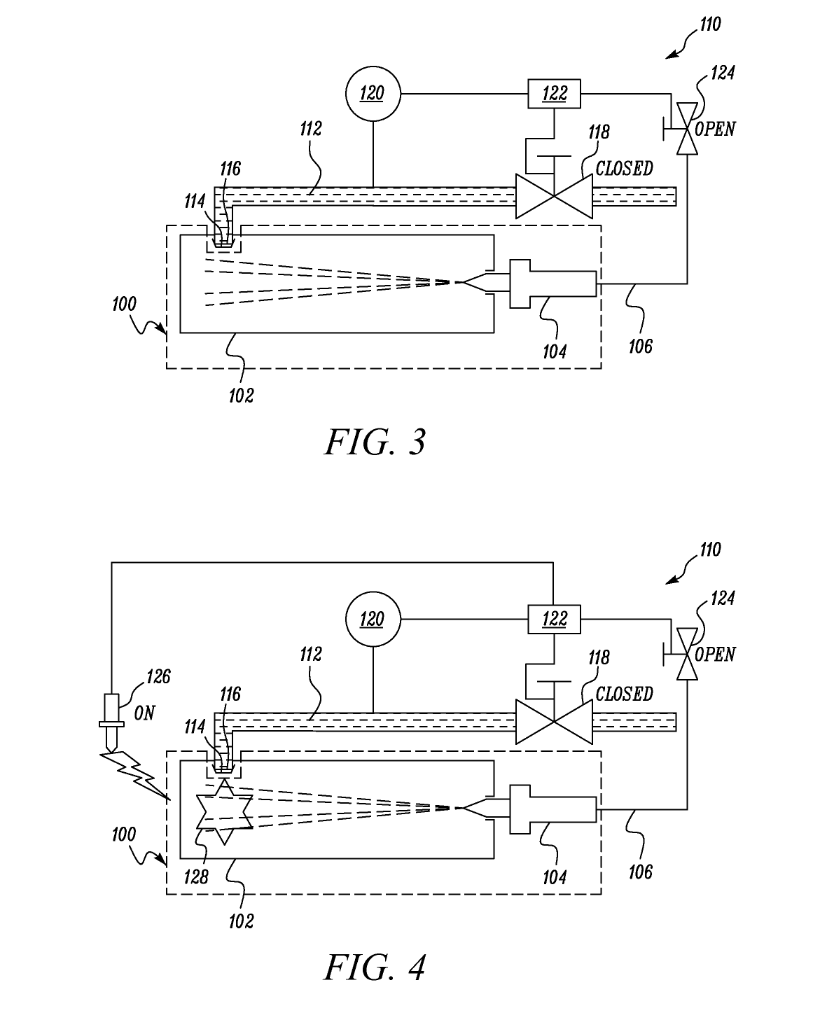

To this end, the pressure transmitter 120 may measure and record the pressure of the extinguishing agent E filled between the fusible component 114 and the first valve 118. Referring to FIG. 3, upon reaching a pre-determined threshold pressure limit within the supply line 112, the pressure transmitter 120 may provide the controller 122 with corresponding signals using which the controller 122 may issue appropriate command signals for the first valve 118 to be closed or shut.

For example, if the pre-determined threshold pressure limit set at the controller 122 is 5 pounds per square inch (psi), and if the pressure of the extinguishing agent E as measured by the pressure transmitter 120 reaches 5 psi, then the controller 122 may command the first valve 118 to be closed or shut. As disclosed earlier herein, the first valve 118 may be beneficially implemented by way of a solenoid operated type of valve, and hence, may be readily configured to receive and execute the command signals from the controller 122. Moreover, closing of the first valve 118 may terminate the flow of the extinguishing agent E into the supply line 112.

With continued reference to FIG. 4, an operation of the combustion system 100 is initiated. To this effect, the controller 122 may command the second valve 124 to be open. Therefore, fuel may be supplied to the injector 104 via the fuel line 106. The injector 104 may, in turn, and supply pressurized fuel to the combustor 102. In an embodiment, a pressure of fuel at the injector 104 and a subsequent velocity of the fuel in the combustor 102 may be allowed to stabilize before ignition is initiated at the combustor 102. The stabilization of pressure in the injector 104, and the velocity of the fuel in the combustor 102 may be achieved by regulating the second valve 124 disposed in the fuel line 106. Moreover, such stabilization, as commonly known to one skilled in the art, may be accomplished in a relatively short span of time i.e., in the ranging of a few milliseconds to a few seconds, for e.g., in 50 milliseconds (50 ms), in 100 milliseconds (100 ms), or up to three seconds (3 sec).

Referring to FIG. 4, the system 100 further includes an ignition system 126 (depicted schematically). The ignition system 126 is configured to ignite fuel that is injected into the combustor 102. Upon stabilizing the flow rate at the injector 104, and the velocity of fuel at the combustor 102, the ignition system 126 may begin to ignite fuel at the combustor 102. It is envisioned that the controller 122 of the present disclosure may be, additionally or optionally, coupled to the ignition system 126 such that the controller 122 may command the ignition system 126 for initiation/commencement, timing, and/or termination of ignition to the fuel at the combustor 102.

In one embodiment, upon ignition of the fuel in the combustor 102, a rate of fuel flow at the injector 104 and the subsequent velocity of the fuel/air mixture in the combustor 102 may be reduced. At this point, a difference between the velocity of fuel/air mixture and the velocity of the flame may decrease, and a flashback condition (schematically represented by a star-shaped polygon 128 in FIGS. 4, 5, and 6) in may occur at the combustor 102. As with many types of combustion systems that are known in the art, the flashback 128 may result in a flame that travels upstream of the fuel flow i.e., from a point of ignition in the combustor 102 towards the injector 104. In some cases, this flame may even come in contact with the injector 104 thus affecting an operation and/or performance of the injector 104.

However, one of ordinary skill in the art will acknowledge that typically, a service life of an injector may deteriorate when a flashback comes into contact therewith. It has also been observed that in some cases, the flashback may altogether damage the injector thereby rendering the injector unfit for further use. Therefore, by way of the systems and methods provided herein, it is contemplated to prevent the flashback 128 from reaching the injector 104 of the combustion system 100.

Moreover, with reference to various embodiments of the present disclosure, it is also contemplated to implement such preventive measures simultaneously with the detection of the flashback 128. Beneficially, such simultaneous implementation of the detection and the preventive measures in respect of flashback 128 may reduce time that was previously required for performing such functions distinctly. Further, such reduction in time may prevent the flashback 128 from reaching the injector 104 of the combustion system 100.

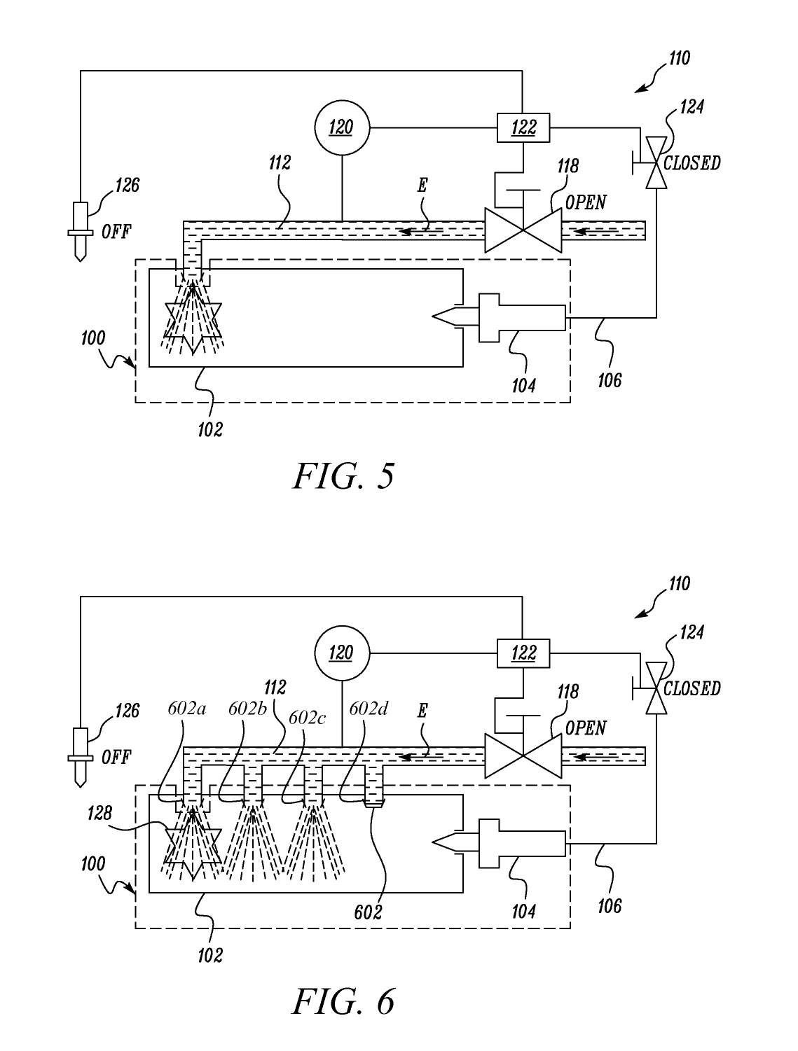

Referring to FIG. 5, the combustion system 100 is shown at an instant after the occurrence of the flashback 128. As known to one skilled in the art, heat associated with normal combustion significantly increases in the event of a flashback. Consequently, the temperature at a localized site of the flashback also increases. The increased temperature, disclosed herein, is likely to be more than the temperature that is usually accompanied with normal operating conditions at the combustor 102.

With increase in the temperature inside the combustor 102, the fusible component 114 affixed to the end 116 of the supply line 112 melts, and disintegrates to release the extinguishing agent E present in the supply line 112. As disclosed earlier herein, the extinguishing agent E may be, for example, but not limited to, carbon dioxide (CO₂), a combination of water (H₂O) and foam, or other dry or wet types of extinguishing agents known in the art. It is envisioned that the release of the extinguishing agent E into the combustor 102 may prevent the flashback 128 from travelling upstream of the flow of fuel/air mixture and coming into contact with the injector 104.

Further, as the extinguishing agent E is being released from the supply line 112, the pressure transmitter 120 may record a pressure drop in the supply line 112. Specifically, as the initially charged supply line 112 is being depleted of the extinguishing agent E, the pressure in the supply line 112 falls below the pre-determined threshold pressure limit. With reference to the preceding example, the pressure now recorded at the pressure transmitter 120 may be, for example, 2 psi as compared to the minimum required pressure i.e., pre-determined threshold pressure limit 5 psi.

Disintegration of the fusible component 114 and the simultaneous release of the extinguishing agent E into the combustor 102 are indicative of the flashback 128 and hence, a resultant effect of the flashback 128 in the combustor 102. The pressure transmitter 120 can therefore, easily detect the occurrence of flashback 128 in the combustor 102 by way of the pressure drop in the supply line 112. Thereafter, the pressure transmitter 120 may correspondingly output signals to the controller 122 to indicate the pressure drop within the supply line 112.

In an embodiment, upon receiving such signals from the pressure transmitter 120, the controller 122 may command the first valve 118 to be opened. Opening of the first valve 118 may allow additional extinguishing agent E to be introduced into the supply line 112 and directly supplied to the combustor 102. With the fusible component 114 now disintegrated, the additional extinguishing agent E can freely flow from the end 116 of the supply line 112 into the combustor 102 for extinguishing the flashback 128.

With reference to the foregoing embodiments, it is envisioned that an amount of extinguishing agent E initially maintained in the charged supply line 112 i.e., between the fusible component 114 and the first valve 118 prior to disintegration of the fusible component 114, is adequate to extinguish the flame and hence, prevent the flashback 128 from reaching the injector 104. However, the controller 122 may also additionally open the first valve 118 in order to release more extinguishing agent E into the combustor 102. This way, the controller 122 may beneficially accomplish ensure complete extinguishment of the flame so that the flashback 128 can be prevented from coming into contact with the injector 104.

In one embodiment, upon receiving signals indicative of the pressure drop in the supply line 112, the controller 122 may, optionally or additionally, also command the second valve 124 to be shut. Shutting the second valve 124 may be performed to restrict the flow of fuel in the fuel line 106 thereby preventing supply of fuel to the injector 104. Notably, with the controller 122 additionally commanding the second valve 124 to be closed in the event of the flashback 128, the possibility for the flashback 128 to reach the injector 104 may be reduced.

In another embodiment, the controller 122 may, additionally or optionally, command a termination of any further ignition of the fuel/air mixture at the combustor 102. As the ignition system 126 is also in an OFF state at this point, no more ignition of fuel occurs at the combustor 102 thereby bringing about a halt in the operation of the combustion system 100.

Moreover, upon detection of the flashback 128 by way of the decreased pressure in the supply line 112, the controller 122 may execute the aforementioned preventive measures simultaneously, or in tandem manner depending upon specific requirements of an application. In one example, the controller 122 may first command the closing of the second valve 124, then terminate ignition of the fuel/air mixture, and may thereafter execute the opening of the first valve 118 to let the extinguishing agent E flow into the combustor 102 that is substantially devoid of any fresh fuel or ignition thereof.

In another example, the controller 122 may simultaneously terminate ignition, and command closing of the second valve 124 and opening of the first valve 118. One of ordinary skill in the art will acknowledge that the controller 122 may be configured to execute the preventive measures in any order or sequence. Therefore, it may be noted that the order or sequence of operating the system 110 is non-limiting of this disclosure. Any order of operation may be implemented in the system 110 of the present disclosure without deviating from the scope of the present disclosure.

FIG. 6 illustrates multiple fusible components 602a, 602b, 602c, and 602d (hereinafter collectively referred to as fusible components 602) installed on the combustor 102. When using more than one fusible component 602, the fusible components 602 may be strategically arranged or located at the combustor 102 depending upon the shape and size of the combustor 102.

As shown, it may be contemplated to beneficially install the multiple fusible components 602 near an outlet of the injector 104. Alternatively, the multiple fusible components 602 may be affixed along a length of the combustor 102 so that one or more fusible components 602 can operatively melt to release the extinguishing agent E within the combustor 102 in the event of a flashback.

A number and locations of the fusible components 602 may be selected such that the fusible components 602 adequately cover an interior volume of the combustor 102. In this manner, flashback 128 occurring at any location within the combustor 102 may be detected without substantial delay, and the extinguishing agent E from the initially charged supply line 112 can be released into the combustor 102 almost instantaneously upon such detection. Thereafter, if required, the controller 122 may command the first valve 118 to open in order to release additional extinguishing agent E into the combustor 102 depending on specific requirements of an application.

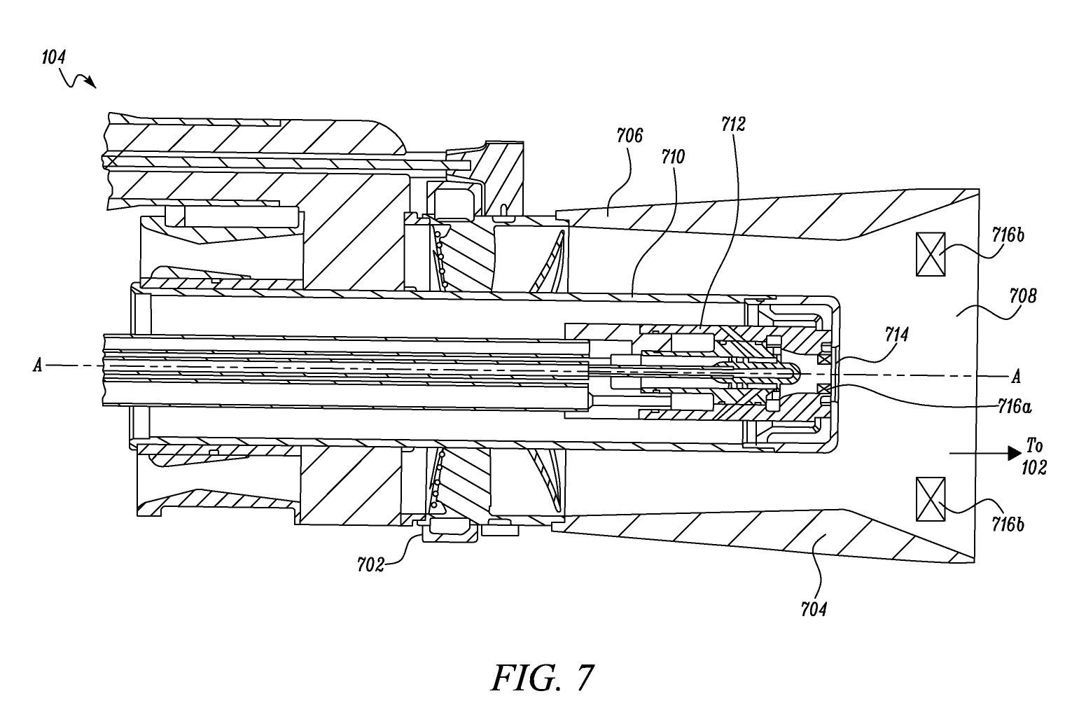

FIG. 7 illustrates an exemplary injector 104 of a gas turbine engine showing locations at which the fusible components 716a, 716b can be beneficially installed to detect flashback 128. The injector 104 may include components that co-operate to inject gaseous and/or liquid fuel into the combustor 102. The injector 104 includes an air inlet duct 702, and a mixing duct 704. The air inlet duct 702 and the mixing duct 704 together define a barrel housing 706 configured to receive compressed air and supply the fuel-air mixture to the combustor 102.

The mixing duct 704 may include a central opening 708 that fluidly communicates the barrel housing 706 with the combustor 102. Moreover, the mixing duct 704 may be configured to axially direct the fuel/air mixture from fuel injector 104 into the combustor 102.

The fuel injector 104 further includes a central body 710. The central body 710 may be disposed radially inward of the barrel housing 706 and aligned along a common axis A-A. The fuel injector 104 may also include a pilot fuel circuit 712 located within the central body 710. The pilot fuel circuit 712 may be configured to inject a pilot stream of pressurized fuel through a tip end 714 of the central body 710 into the combustor 102 to facilitate engine starting, idling, cold operation, and/or lean burn operations of a gas turbine engine.

As shown, a first fusible component 716a may be installed at the tip end 714 of the central body 710, and a second fusible component 716b may be installed at the central opening 708 of the mixing duct 704. With this exemplary arrangement, it is envisioned that the flashback 128 may be extinguished at or near the tip end 714 of the central body 710 and hence, prevented from travelling upstream of the fuel/air mixture. However, it is to be noted that these locations are merely exemplary in nature and hence, non-limiting of this disclosure. Any suitable location on the injector 104 may be selected depending on specific requirements of an application and/or other factors such as, but not limited to, injector design, availability of space, and other constraints commonly known to one skilled in the art.

Although various embodiments of the system 110 are explained in the foregoing disclosure, the system 110 of the present disclosure is recapitulated in a different manner as appended in the claims. Referring to FIG. 1, in accordance with an alternative embodiment of the present disclosure, the system 110 includes the supply line 112 charged with the extinguishing agent E. The supply line 112 is coupled to the combustor 102. The supply line 112 defines an end 116 configured to face with the combustor 102. Moreover, the end 116 of the supply line 112 is provided with the fusible component 114 that is configured to melt in the event of flashback 128, and release the extinguishing agent E into the combustor 102.

Various embodiments disclosed herein are to be taken in the illustrative and explanatory sense, and should in no way be construed as limiting of the present disclosure. All numerical terms, such as, but not limited to, “first”, “second”, “third”, or any other ordinary and/or numerical terms, should also be taken only as identifiers, to assist the reader's understanding of the various embodiments, variations and/ or modifications of the present disclosure, and may not create any limitations, particularly as to the order, or preference, of any embodiment, variation and/or modification relative to, or over, another embodiment, variation and/or modification.

Moreover, joinder references (e.g., attached, affixed, coupled, connected, and the like) are only used for identification purposes to aid the reader's understanding of the present disclosure, and may not create limitations, particularly as to the position, orientation, or use of the devices and/or methods disclosed herein. Therefore, such joinder references are to be construed broadly. Moreover, such joinder references do not necessarily infer that two elements are directly connected to each other.

Additionally, in methodologies directly or indirectly set forth herein, various steps and operations are described in one possible order of operation, but those skilled in the art will recognize that steps and operations may be rearranged, replaced, or eliminated without departing from the spirit and scope of the present disclosure as set forth in the claims.

It is to be understood that individual features shown or described for one embodiment may be combined with individual features shown or described for another embodiment. It is to be understood some features are shown or described to illustrate the use of the present disclosure in the context of functional segments and such features may be omitted within the scope of the present disclosure and without departing from the spirit of the present disclosure as defined in the appended claims.

### INDUSTRIAL APPLICABILITY

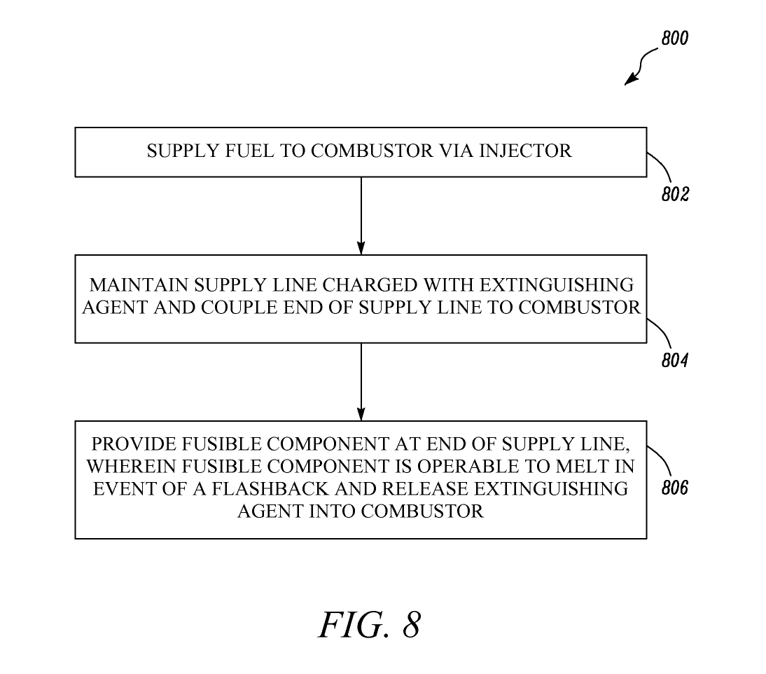

Explanation pertaining to the working of the system 110 will be made with reference to FIG. 8. FIG. 8 shows a method of detecting a flashback condition in the combustion system 100. At step 802, the method includes supplying fuel to the combustor 102 via the injector 104.

At step 804, the method further includes maintaining the supply line 112 charged with the extinguishing agent E. As such, the end 116 of the supply line 112 is coupled to the combustor 102 and a pre-determined amount of extinguishing agent E is maintained between the fusible component 114 and the first valve 118.

At step 806, the method further includes providing the fusible component 114 at the end 116 of the supply line 112 such that the fusible component 114 is operable to melt in the event of a flashback and release the extinguishing agent E into the combustor 102.

In an embodiment as disclosed earlier herein, the fusible component 114 may be configured to melt at a temperature in the range of 900 to 2000 degrees Fahrenheit. In a further embodiment, the fusible component 114 may be configured to melt at a temperature of 1000 degrees Fahrenheit. In an alternative embodiment, the fusible component 114 may be configured to melt at a temperature of 1300 degrees Fahrenheit. Although some exemplary values of temperatures have been disclosed in the present disclosure, one of ordinary skill in the art will acknowledge that it is possible to change the melting point temperature of the fusible material by changing a material and/or structure of the fusible component 114. Therefore, it may be noted that other values of temperatures may be implemented depending on specific requirements of an application without deviating from the spirit of the present disclosure.

Combustion systems are typically designed to avoid flashback. However, flashback may occur under various operating conditions and in some cases, may be intrinsic to the design of the combustion system. Manufacturers typically experience difficulty in detecting a flashback condition until damage has already been done to the injector or other associated hardware provided in the combustion system. The present disclosure, however, allows manufactures to detect a flashback condition without substantial delay. As the system 110 disclosed herein accomplishes detection of a flashback by way of releasing the extinguishing agent, the system 110 prevents the flashback from coming into contact with the injector without substantial delay. The preventive measures i.e., opening of the first valve 118, closing of the second valve 124, and/or terminating the ignition of fuel/air mixture may be implemented simultaneously with detection of the flashback, or in a tandem manner upon detection of the flashback.

Therefore, the simultaneous, tandem, or concurrent manner of detecting and extinguishing the flashback allows manufacturers to prevent the injector from being damaged or deteriorated by the flashback. Accordingly, the manufacturers can beneficially repeat testing procedures on newly designed combustion systems by re-using a single injector several times during the repeated tests. It is envisioned that the re-use of injectors in laboratory testing may provide consistent results as the same injector is used relative to the designed combustion system. Therefore, the present disclosure allows manufacturers to offset and save costs that were previously incurred in testing combustion systems using conventional testing procedures. Moreover, manufacturers can also beneficially implement the present system 110 in field testing applications where the associated combustion system executes operation in a real-time environment.

While aspects of the present disclosure have been particularly shown and described with reference to the embodiments above, it will be understood by those skilled in the art that various additional embodiments may be contemplated by the modification of the disclosed machine, systems and methods without departing from the spirit and scope of what is disclosed. Such embodiments should be understood to fall within the scope of the present disclosure as determined based upon the claims and any equivalents thereof.

We claim:

1. A system for system for detecting a flashback condition and mitigating damage from the flashback in a combustion system having an injector and a combustor, the system comprising:
a supply line charged with an extinguishing agent and coupled to the combustor, the supply line defining an end configured to face with the combustor, wherein the end is made provided with a fusible component that is configured to melt in the event of a flashback, and release an extinguishing agent into the combustor;
a first valve disposed in the supply line and located upstream of the fusible component, the first valve configured to regulate a supply of the extinguishing agent in the supply line;
a pressure transmitter disposed in the supply line and located between the fusible component and the first valve, the pressure transmitter configured to measure a pressure of the extinguishing agent; and
a controller communicably coupled to the pressure transmitter, the controller configured to open the first valve in the event of flashback.

2. The system of claim 1 further including a fuel line coupled to the injector, the fuel line including a second valve disposed therein, the second valve configured to regulate a supply of fuel to the injector.

3. The system of claim 2, wherein the controller is configured to shut off the second valve in the event of a flashback.

4. The system of claim 1, wherein the fusible component is selected from one of a metal and an alloy.

5. The system of claim 1, wherein the fusible component is configured to melt at a temperature in the range of 900 to 2000 degrees Fahrenheit.

6. The system of claim 1, wherein the fusible component is configured to melt at a temperature of 1000 degrees Fahrenheit.

7. A combustion system including:
a combustor configured to combust a mixture of fuel and air;
an injector configured to operatively supply pressurized fuel to the combustor; and
employing the system of claim 1.

8. A gas turbine engine including:
a pilot injector circuit; and
employing the system of claim 1.

9. The gas turbine engine of claim 8, wherein the system is located proximal to an outlet of the pilot injector circuit.

10. A system for detecting a flashback condition and mitigating damage from the flashback in a combustion system having an injector and a combustor, the system comprising:
a supply line located downstream of the injector and coupled to the combustor, the supply line configured to selectively supply an extinguishing agent within the combustor; and
a fusible component affixed to an end of the supply line, wherein the fusible component is operable to melt in the event of a flashback and release the extinguishing agent into the combustor;
a first valve disposed upstream of the fusible component;
a second valve disposed upstream of the injector and configured to regulate a supply of fuel to the injector;
a pressure transmitter disposed in the supply line and located between the fusible component and the first valve, the pressure transmitter configured to measure a pressure of the extinguishing agent; and
a controller communicably coupled to the pressure transmitter, the controller configured to perform one or more of opening the first valve and shutting off the second valve when a pressure of the extinguishing agent maintained between the fusible component and the first valve falls below a pre-determined threshold pressure limit.

11. The system of claim 11, wherein the fusible component is configured to melt at a temperature in the range of 900 to 2000 degrees Fahrenheit.

12. A gas turbine engine including:
a pilot injector circuit; and
employing the system of claim 1, wherein the system is located proximal to an outlet of the pilot injector circuit.

13. A method of detecting a flashback condition and mitigating damage from the flashback in a combustion system having an injector and a combustor, the method comprising:
supplying fuel to the combustor via the injector;
maintaining a supply line charged with an extinguishing agent, wherein an end of the supply line is coupled to the combustor; and
providing a fusible component at the end of the supply line, the fusible component operable to melt in the event of a flashback and release the extinguishing agent into the combustor.

14. The method of claim 13 further comprising a first valve disposed in the supply line and located upstream of the fusible component.

15. The method of claim 14 further comprising maintaining a pre-determined amount of extinguishing agent between the fusible component and the first valve.

16. The method of claim 15 further comprising opening the first valve when a pressure of the extinguishing agent maintained between the fusible component and the first valve falls below a pre-determined threshold pressure limit.

17. The method of claim 16 further comprising providing a second valve disposed upstream of the injector, wherein the second valve is configured to regulate a supply of fuel to the injector.

18. The method of claim 17 further shutting off the second valve when a pressure of the extinguishing agent maintained between the fusible component and the first valve falls below a pre-determined threshold pressure limit.

19. The method of claim 13, wherein the fusible component is configured to melt at a temperature in the range of 900 to 2000 degrees Fahrenheit.

20. The method of claim 13, wherein the fusible component is configured to melt at a temperature of 1000 degrees Fahrenheit.
